(19) United States
(12) Patent Application Publication
(10) Pub. No.: US 2005/0253835 A1
(43) Pub. Date: Nov. 17, 2005

(54) Active matrix type of display unit and method for driving the same

(75) Inventor: Kimitaka Kawase, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/100,481

(22) Filed: Apr. 7, 2005

(30) Foreign Application Priority Data
Apr. 19, 2004 (JP) P2004-122628

(51) Int. Cl. G09G 5/00

(52) U.S. Cl. 345/207

(57) ABSTRACT

An organic EL active matrix type of display apparatus includes an illuminance detector for detecting brightness of an ambient environment, a calculating section for calculating a brightness set value corresponding to an output from the illuminance detector, and a duty scanning drive circuit as a control unit for controlling a light emission period of time of an organic EL element according to the brightness set value calculated in this calculating section. The light emission period of time of the organic EL element can be controlled according to a percentage (duty) of a light emission period of time within one scanning cycle. With this duty control, display brightness can easily and smoothly be adjusted. Further the dynamic range is not narrowed, so high image quality can be maintained even at a dark place.

### BACKGROUND OF THE INVENTION

The present invention relates to an active matrix type of display unit having an active element for each pixel and providing display control for each pixel with this active element and a method of driving the same, and more specifically an active matrix type of display unit with the display brightness automatically adjustable according to an ambient brightness for upgrading the image quality, saving power, and prolonging the operating life, and a method of driving the same.

Recently there have been made active efforts for development of an organic electroluminescence element display unit using an organic electroluminescent display element (described as organic EL element hereinafter) as one of plane display unit. The organic EL element display device is self-luminous and does not need use of a back light, and in addition is excellent in the performance adapted to moving picture, wide view angle, and color reproducing capability and the like, and gathers hot attentions as a next generation thin type display unit.

Generally in the organic EL display unit, scanning lines each for selecting a pixel with a predetermined scanning cycle and data lines for giving brightness information for driving the pixel are arranged in the matrix form, and a light emitting element (organic EL element) is provided at and near each of crossing points of the scanning lines with the data lines, and an image is displayed and driven by controlling the luminescence intensity for each pixel according to image information to be displayed. The driving system for this type of organic EL display unit is divided to, like in the case of a liquid crystal display unit, the simple (passive) matrix system and the active matrix system.

In the simple matrix system, a current flowing through a light emitting element provided at each pixel is controlled according to a voltage between a scanning electrode and a data electrode, while, in the active matrix system, a current flowing through a light emitting element for each pixel is controlled by an active element provided in the pixel. In the simple matrix system, light is emitted transitionally when each light emitting element is selected, but in the active matrix system, luminescence in each pixel can be maintained for one frame period, so that the active matrix system is more suited to scaling up the size of and finer and brighter images in a display unit because peak brightness of each light emitting element and a peak current can be lowered more as compared to the simple matrix system.

When the organic EL display unit is used as a display for a portable terminal device or a mobile device such as a video camera, peripheral brightness varies according to an environment for use thereof, and sometimes a user of the display can hardly recognize the displayed contents. To solve this problem, it can be considered that the display brightness is set to a relatively large value so that the user can easily recognize the displayed contents in various environments.

When the display brightness is set to a relatively large value, however, the display is too bright at a dark place, which rather makes it difficult to recognize the displayed contents. Further the power consumption becomes unnecessarily larger, and an operating life of the organic EL display unit is disadvantageously shortened.

Therefore, if it is possible for a display unit to adjust the display brightness of a display unit according to the peripheral brightness, the brightness can be made higher at a bright place, and also the brightness can be made lower at a dark place, so that the excellent visibility of a display unit can be ensured regardless of the environment for use thereof, which also can contribute to power saving as well as prolonging of the operating life of the element.

As described above, as a technique for adjusting display brightness of a display unit according to the ambient brightness, for instance, Japanese Patent Laid-Open No. 2001-100697 discloses a display unit having a display section with a plurality of pixels for displaying information, a driving unit for driving this display section, an illuminance detector for detecting a value corresponding to ambient brightness to the display section, and a brightness control unit for controlling brightness of the display section according to a result of detection by the illuminance detector.

The Japanese Patent Laid-Open No. 2001-60076 discloses the configuration of a voltage write type of pixel circuit and a current write type of pixel circuit as a format for writing brightness information in a pixel respectively in the active matrix type of organic EL display unit.

In the display unit described in Japanese Patent Laid-Open No. 2001-100697, brightness of an ambient environment is detected by an illuminance detector, and a brightness control signal for each pixel corresponding to a result of detection by this illuminance detector is calculated by an illuminance control unit to adjust the display brightness.

However, in the display unit described in Japanese Patent Laid-Open No. 2001-100697, both control over brightness in response to the brightness control signal data and control over the brightness corresponding to the brightness detected by the illuminance detector are performed by the brightness control unit, so image signals and brightness detection signals are intermingled and complicated operations and processing are required to respond to the complicated situation.

Further when used in a dark environment, the brightness is set to a relatively lower value, it is necessary to control the luminance intensity of a light emitting element with a small drive voltage range, so the dynamic range is disadvantageously degraded. Because of the feature, degradation of image display quality inevitably occurs due to a small noise or non-uniformity in characteristics of elements.

### SUMMARY OF THE INVENTION

The present invention was made in the light of the circumstances as described above, and it is an object of the present invention to provide an active matrix type of display unit enabling easy adjustment of display brightness in response to brightness of the ambient environment without narrowing the dynamic range and a method of driving the display unit.

To solve the problems as described above, in the active matrix type of display apparatus according to the present invention, scanning lines each for selecting a pixel with a predetermined scanning cycle, data lines each for giving brightness information for driving a pixel, and a pixel circuit for making a light emitting element emit light by controlling a current rate according to the brightness information are arranged in the matrix state. The display apparatus includes an illuminance detector for detecting illuminance of the ambient environment and a control unit for controlling light emitting time of the light emitting element according to an output from the illuminance detector.

A method of driving the active matrix type of display apparatus according to the present invention is employed for an active matrix type of display apparatus in which scanning lines each for selecting a pixel with a predetermined scanning cycle, data lines each for giving brightness information for driving a pixel, and a pixel circuit for making a light emitting element emit light by controlling a current rate according to the brightness information are arranged in the matrix state. Light emitting elements emit light in response to scanning for selection of a scanning line by a scanning drive unit and driving for selection by a data drive unit via a data line. The method includes the steps of: detecting illuminance of the ambient environment, calculating a light emitting period of time according to the detected illuminance, and controlling the scanning drive unit according to the calculated light emitting period of time.

In the present invention, a result of detection by the illuminance detector is calculated or processed as a control rate for a light emitting period of time of a light emitting element under control by the control unit independent from the brightness information provided by an image signal supplied from the data drive unit. Control over the light emitting period of time includes adjustment of average brightness of pixels in one scanning cycle. Therefore, by controlling a light emitting period of time of a light emitting element according to illuminance of the ambient environment, namely brightness of external light, it is possible to easily and freely adjust the display brightness without narrowing a dynamic range.

Control over a light emitting period of time of a light emitting element can easily be carried out by adjusting a percentage (duty) of a light emitting period of time in one light emitting cycle. In other words, the average brightness of pixels in one scanning cycle can easily be adjusted according to a degree of duty.

The pixel circuit for realizing the configuration described above includes an active element for write scanning for writing brightness information controlled by the scanning line and given from the data line in a pixel, an active element for driving for controlling a rate of a current to be supplied to the light emitting element according to the written brightness information, a storage capacity for storing therein the brightness information, and an active element for lighting out a light emitting element emitting light, and a light emitting period of time of a light emitting element can be controlled by controlling driving timing for the write scanning active element or driving timing for the active element for lighting out. The writing scheme of the brightness information may be either of the so-called voltage write type or the current write type.

Various types of self-luminous elements such as an organic electroluminescence element, an inorganic electroluminescence element, and a light-emitting diode may be used as the light emitting element used in the present invention. Especially, when the present invention is applied to an organic electroluminescence display unit, the power consumption and the operating life of the element can be improved by adjusting the optimal brightness according to the brightness of the environment for use thereof.

As described above, with the present invention, as the display brightness can be adjusted by controlling a light emitting period of time of a light emitting element, the display brightness can freely be adjusted according to illuminance (brightness) of an environment for use thereof.

Further the dynamic range is not narrowed, so that degradation of display quality of an image caused by slight noises or non-uniformity in performance of elements can be prevented, and high quality images can always be displayed regardless of the environment for use thereof.

### BRIEF DESCRIPTION OF THE DRAWINGS

FIG. 1 is a general block diagram showing an active matrix type of display unit according to an embodiment of the present invention;

FIG. 2 is a view illustrating configuration of the organic EL display unit;

FIG. 3 is a circuit diagram showing configuration of a voltage write type of pixel circuit;

FIG. 4 is a timing chart showing an example of an operation of the voltage write type of the pixel circuit;

FIG. 5 is a circuit diagram showing configuration of a current write type of pixel circuit;

FIG. 6 is a timing chart showing an example of an operation of the current write type of the pixel circuit;

FIG. 7 is a view showing an example of a control signal sent from a scanning control drive section to a duty scanning drive circuit;

FIG. 8 is a graph showing an example of control over the illumination brightness of an organic EL element for illuminance of the ambient environment detected by an illuminance detector; and

FIG. 9 is a view showing a variant of the configuration of the active matrix type of display unit.

### DETAILED DESCRIPTION OF PREFERRED EMBODIMENT

An embodiment of the present invention is described below with reference to the related drawings. In this embodiment, an organic EL active matrix type of display unit using an organic EL element is described as an example of a light emitting element constituting each pixel.

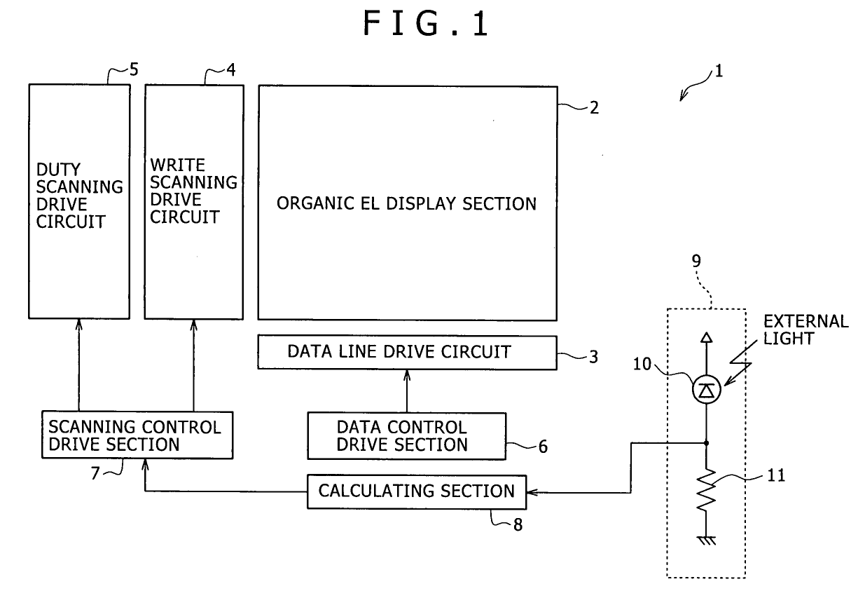

FIG. 1 is a general block diagram showing an active matrix type of display unit according to an embodiment of the present invention. The organic EL active matrix type of display unit 1 includes an organic EL display section 2, a data line drive circuit 3, a write scanning drive circuit 4, a duty scanning drive circuit 5, a data control drive section 6, a scanning control drive section 7, a calculating section 8, and an illuminance detector 9, and adjusts the display brightness of the organic EL display section 2 in response to illuminance (brightness of external light) of the ambient environment detected by the illuminance detector 9.

At first, configuration of the organic EL display section 2 is described in detail.

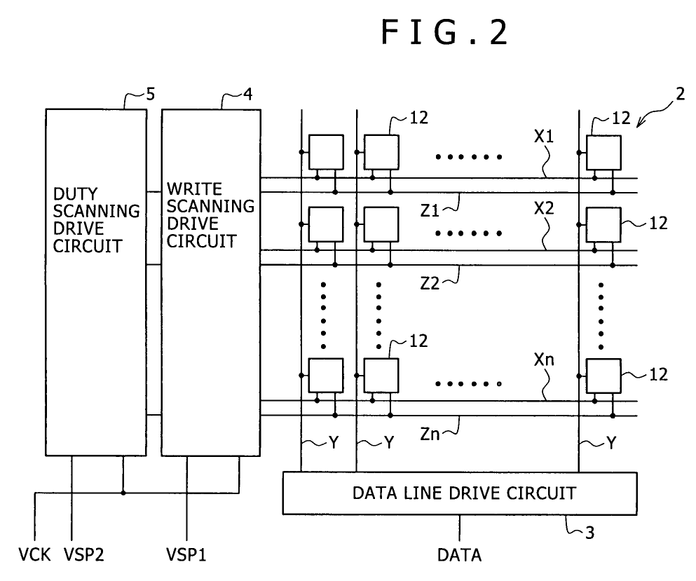

FIG. 2 shows general configuration of the organic EL display section 2. As shown in this figure, a plurality of write scanning lines X (X1, X2, . . . Xn) are arranged as lines, while a plurality of data lines Y are arranged as rows. A pixel 12 is provided at a crossing point of each write scanning line X with the data line Y. Further, in parallel to the write scanning lines X, a plurality of duty control lines Z (Z1, Z2, . . . Zn) are arranged like lines.

The write scanning line X is connected to the write scanning drive circuit 4. The write scanning circuit 4 includes a shift register, and a vertical clock VCK and a vertical start pulse VSP1 are supplied thereto from the scanning control drive section 7 (FIG. 1). By successively transferring the vertical start pulse VSP1 in synchronism to the vertical clock VCK, the scanning lines X1, X2, . . . Xn are successively selected within one scanning cycle.

On the other hand, the duty control line Z is connected to the duty scanning drive circuit 5. Also this duty scanning drive circuit 5 includes a shift register, and a vertical clock signal line VCK and a vertical start pulse signal line VSP2 is connected thereto. By successively transferring the vertical start pulse VSP2 in synchronism to the vertical clock VCK, a control signal is outputted to the duty control line Z.

The data line Y is connected to the data line drive circuit 3. The data line drive circuit 3 outputs an electric signal corresponding to the brightness information for each data line Y supplied from the data control drive section 6 (FIG. 1) in synchronism to successive scanning for each scanning line X. In this case, the data line drive circuit 3 performs the so-called line by line successive driving, and simultaneously supplies electric signals to a selected pixel line. Alternatively, the data line drive circuit 3 may perform the so-called dot by dot successive driving, and successively supply an electric signal to pixels in the selected line. The present invention includes the two operating modes of line by line successive driving and dot by dot successive driving.

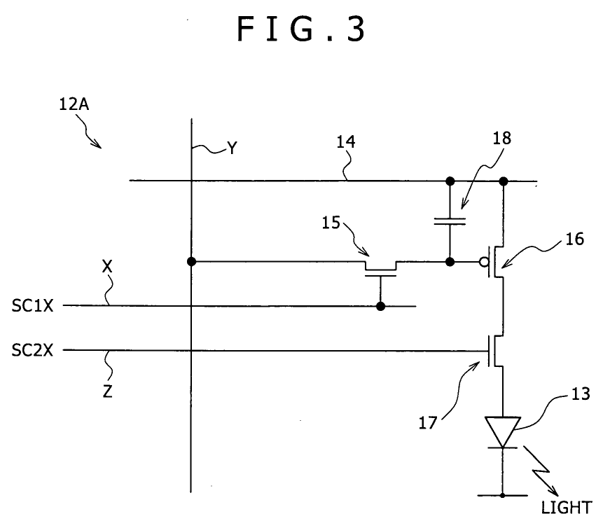

FIG. 3 shows an example of configuration of a pixel 12 of the organic EL display section 2. The circuit shown in FIG. 3 is a voltage write type of pixel circuit 12A which writes brightness information by controlling a voltage for the data line Y. This pixel circuit 12A includes an organic EL element 13, a current supply line 14, a data line Y, a write scanning line X, a duty scanning line Z, an N type write scanning transistor 15, a P type drive transistor 16, an N type duty control transistor 17, and a storage capacity 18.

A source (or a drain) of the N type write scanning transistor 15 is connected to a gate of the P type drive transistor 16, and a drain (or a source) thereof is connected to the data line Y. A gate of the N type write scanning transistor 15 is connected to the write scanning line X. A source of the P type drive transistor 16 is connected to the current supply line 14, and a drain thereof is connected to a source of the N type duty control transistor 17. A gate of the duty control transistor 17 is connected to the duty scanning line Z, and a drain thereof is connected to an anode of the organic EL element 13. One terminal of the storage capacity 18 is connected to a gate of the P type drive transistor 16, and another terminal thereof is connected to the current supply line 14.

The N type write scanning transistor 15, the drive transistor 16, and the duty control transistor 17 correspond to the “active element for write scanning”, “active element for driving”, and “active element for lighting out” respectively, and in this embodiment, a field effect transistor such as a polysilicon TFT is used. Further in this view, each of write scanning transistor 15 and duty control transistor 17 is composed of an N-type transistor, but either one or both of the transistors may be composed of a P-type transistor or P-type transistors.

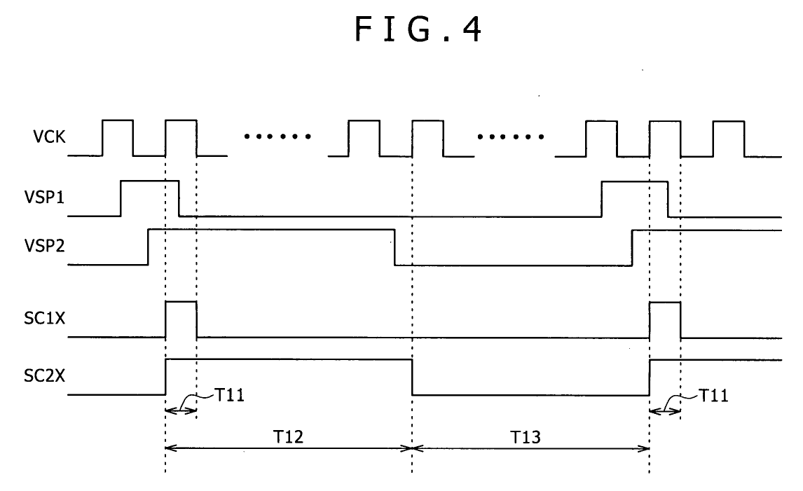

An example of an operation of the pixel circuit 12A is described below with reference to the timing chart shown in FIG. 4.

As shown in FIG. 4, the vertical clock VCK is given to the write scanning circuit 4 as well as to the duty scanning drive circuit 5 shown in FIG. 1. Further the start pulse VSP1 is given to the write scanning drive circuit 4, and the vertical start pulse VSP2 is given to the duty scanning drive circuit 5. Each of the write scanning circuit 4 and duty scanning drive circuit 5 incorporates a shift register, and transfers the vertical start pulses VSP1 and VSP2 according to the timing of the vertical clock VCK to a shift register in the next stage. In FIG. 4, each of the signals SC1X and SC2X is indicates a pulse based on the vertical start pulses VSP1 and VSP2 respectively, outputted from the sift register in one stage of the write scanning line X and the duty scanning line Z in synchronism to the vertical clock VCK.

In FIG. 4, both the signals SC1X and SC2X go to the H (High) level during the period of T11, and the N type write scanning transistor 15 and duty control transistor 17 in FIG. 3 are turned ON simultaneously. Then a gate of the drive transistor 16 is connected to the data line Y, and a drain of the drive transistor 16 is connected to an anode of the organic EL element 13. During this period of time T11, a voltage corresponding to data brightness is given via the data line Y to the drive transistor 16, and a current corresponding to the data line voltage is given via the current supply line 14 to the organic EL element 13 through voltage current conversion by the drive transistor 16. With this operation, the organic EL element 13 emits light with intensity corresponding to the drive current. This period of time T11 is described hereinafter as write period.

After the period of time T11 is over, when the signal SC2X is kept at a H (high) level and the signal SC1X is changed to a L (Low) level, the N type write scanning transistor 15 goes OFF, and the data line Y is disconnected from the gate of the drive transistor 16. In this step, the gate of the drive transistor 16 is maintained at the same voltage by the storage capacity 18. Namely, the voltage given during the write period T11 is maintained. Further as the duty control transistor 17 is ON, also the drive current given in the write period T11 is maintained, so that the illumination intensity of the organic EL element is maintained.

In FIG. 4, after the period of time T12 is over, when the signal SC2X changes from the H level to the low level, the duty control transistor 17 goes OFF, and a drain of the drive transistor 16 is disconnected from an anode of the organic EL element 13. With this operation, a current does not flow to the organic EL element 13, and light emission is stopped. Therefore this period of time T12 is described as a light ON period.

In the next scanning cycle, both of the signals SC1X and SC2X go high, and the write period T11 is restarted. So the period of time T13 from the end of the light ON period T12 until start of the next write period T11 is described as light OFF period.

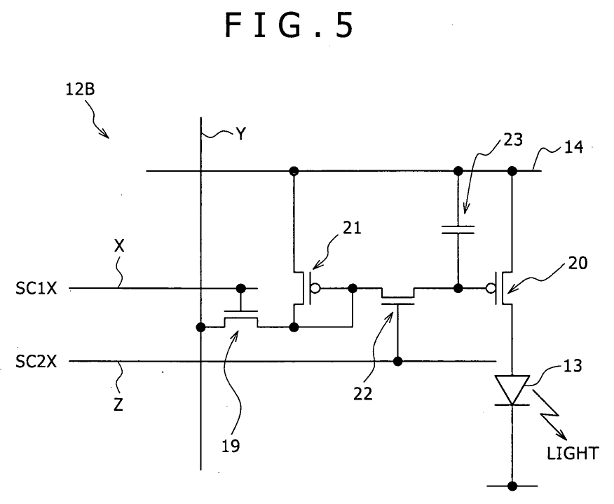

FIG. 5 shows another example of configuration of the pixel 12 in the organic EL display section 2, and shows a current write type of pixel circuit 12B which writes brightness information by controlling a current for the data line Y. This pixel circuit 12B includes an organic EL element 13, a current supply line 14, a data line Y, a write scanning line X, a duty scanning line Z, an N type of write scanning transistor 19, a P type of drive transistor 20, a P type of write transistor 21, an N type of delete scanning transistor 22, and a storage capacity 23.

A source (or a drain) of the write scanning transistor 19 is connected to a drain of the write transistor 21, and a drain (or a source) thereof is connected to the data line Y. Connected to a gate of the write scanning transistor 19 is the write scanning line X. A gate and a drain of the write transistor 21 are short-circuited, and the source is connected to the current supply line 14. A source (or a drain) of the delete scanning transistor 22 is connected to a gate of the write transistor 21, and the drain (or a source) is connected to a gate of the drive transistor 20. Connected to a gate of the delete scanning transistor 22 is the duty scanning line Z. A source of the drive transistor 20 is connected to the current supply line 14, and a drain thereof is connected to an anode of the organic EL element 13. Further one terminal of the storage capacity 23 is connected to a gate of the drive transistor 20, and another terminal thereof is connected to the current supply line 14.

The write scanning transistor 19 and write transistor 21 correspond to the “active element for write scanning” and the drive transistor 20 corresponds to the “active element for driving” in the present invention. Further the delete scanning transistor 22 corresponds to the “active element for lighting out” in the present invention. In this figure, the write scanning transistor 19 and the delete scanning transistor 22 are N-type transistors, but either one or both of the transistors may be a P-type transistor or P-type transistors.

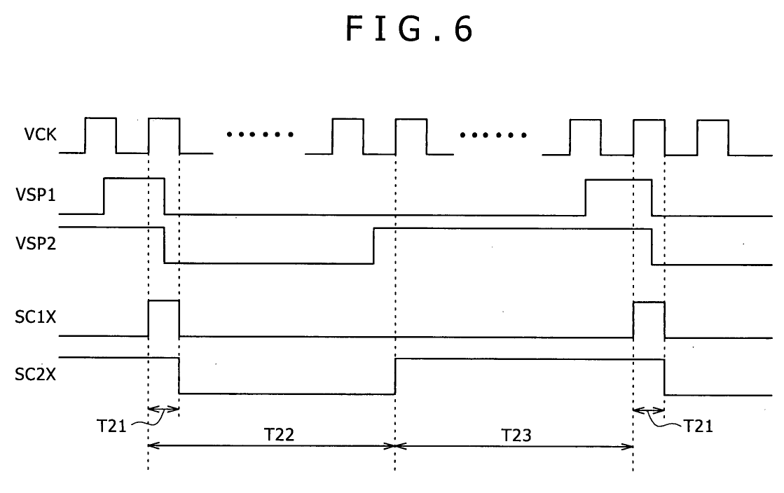

An example of an operation of the pixel circuit 12B is described below with reference to the timing chart in FIG. 6.

In FIG. 6, in a period of time T21, both the signals SC1X and SC2X go to an H level, and the write scanning transistor 19 and the delete scanning transistor 22 shown in FIG. 5 are turned ON simultaneously. Then, a drain of the write transistor 21 is connected to the data line Y, and during this period of time T21, a current corresponding to the data brightness is fetched from the data line Y and is converted to a voltage by the write transistor 21 and is stored in the storage capacity 23. Then a current corresponding to the voltage stored in the storage capacity 23 is supplied from the current supply line 14 to the organic EL element 13. With this configuration, the organic EL element 13 emits light with the intensity corresponding to the drive current. This period of time T21 is described as a write period below.

After the period of time T21 is over, with both of the signals SC1X and SC2X change to an L level (Low), the write scanning transistor 19 and the delete scanning transistor 22 are turned OFF simultaneously. In this step, a voltage at a gate of the drive transistor 20 is maintained by the storage capacity 23. Namely the voltage given in the period of time T21 is maintained. Also the drive current given in the period of time T21 is maintained, and the illuminance intensity of the organic El element is maintained.

In FIG. 6, after the period of time T22 is over, when the signal SC2X changes from the low level to the high level, the delete scanning transistor 22 is turned ON, and a gate of the write transistor 21 is connected to a gate of the drive transistor 20. As a gate and a drain of the write transistor 21 are short-circuited, a current is supplied from the current supply line to the gates of the write transistor 21 and drive transistor 20 via the write transistor 21 respectively, so the voltage stored in the storage capacity 23 is raised, and a current comes not to flow between a source and a drain of the drive transistor 20. Because of this operation, a current does not flow to the organic EL element 13, and light emission is stopped. Therefore this period of time T22 is described as a light ON period hereinafter.

Then the signals SC1X and SC2X go high in the next scanning cycle, and the write period T21 is restarted. Therefore the period of time T23 from the end of the light ON period T22 until start of the next write period T21 is described as light OFF period hereinafter.

As described above, in the organic EL display section 2, a light-emitting operation of the organic EL element 13 is performed by the pixel circuit 12A (or 12B) pixel by pixel in response to selection scanning for the write scanning line X by the write scanning drive circuit 4 and selection driving by the data line drive circuit 3 via the data line Y. With the operations described above, a screen corresponding to the brightness information from the data line drive circuit 3 is driven for displaying with a predetermined scanning cycle in the organic EL display section 2.

The organic EL active matrix type of display unit 1 according to the present invention has a function for adjusting display brightness of the screen according to brightness of the environment for use thereof. The screen brightness adjusting mechanism according to the present invention is described below.

Referring to FIG. 1, the illuminance detector 9 includes an illuminance sensor 10 including a light receiving sensor or the like and a resistor 11, and is provided, for instance, at a position close to the organic EL display section 2 on the same plane as the organic EL display section 2. The illuminance sensor 10 generates a proportional amount of current to the intensity (brightness) of external light with the photoelectric conversion effect. The current generated by the illuminance sensor 10 is converted to a voltage signal by the resistor 11 and then supplied to the calculating section 8. Supply of an output from the illuminance detector 9 to the calculating section 8 is performed, for instance, in synchronism to a scanning cycle of the write scanning line X.

The calculating section 8 includes, for instance, an A/D converter, and digitalizes a terminal voltage between the illuminance sensor 10 and the resistor 11 with this A/D converter. Further the calculating section 8 has a calculating mechanism for calculating the brightness corresponding to the value digitalized by the A/D converter, and supplies a brightness set value calculated by this calculating mechanism to the scanning control drive section 7.

The scanning control drive section 7 supplies, as described above, a vertical clock VCK and a vertical start pulse VSP1 to the write scanning drive circuit 4 and executes selection scanning for the write scanning line X. The scanning control drive section 7, write scanning drive circuit 4, and duty scanning drive circuit 5 composes the “scanning drive unit” according to the present invention, and drives screen displays on the organic EL display section 2 together with the “data drive unit” formed with the data control drive section 6 and data line drive circuit 3. The data control drive section 6 and scanning control drive section 7 may be formed in the same IC.

The scanning control drive section 7 supplies the vertical clock VCK and vertical start pulse VSP2 to the duty scanning drive circuit 5 as described above to control a light emission period of time for the organic EL element 13 of each pixel within one scanning cycle. The light emission period of time of the organic EL element 13 is adjusted according to a result of detection by the illuminance detector 9. Namely, when the ambient environment is bright, light emission of the organic EL element 13 is continued for a relatively long period of time enabling acquisition of a large brightness set value, and when the ambient environment is dark, light emission of the organic EL element 13 is conducted for a relatively short period of time for achieving a small brightness set value.

The brightness set value calculated by the calculating section 8 based on brightness of an ambient environment detected by the illuminance detector 9 is used as a control parameter for deciding a light emission period of time for the organic EL element 13. Namely the scanning control drive section 7 converts a brightness set value supplied from the calculating section 8 to a pulse and supplies the pulse as a control signal to the duty scanning drive circuit 5 to adjust the average brightness of a screen within one scanning cycle for obtaining the screen brightness corresponding to the ambient environment.

The brightness set value is not always calculated based on an output from the illuminance detector 9 and through a predetermined arithmetic expression, and also the configuration is allowable in which a correspondence table between brightness set values and output values from the illuminance detector 9 may be previously stored and a brightness set value suited to the current ambient environment may be selected.

In the embodiment described above, adjustment of the light emission period of time of the organic EL element 13 can be performed by controlling the timing for stopping light emission given by the duty scanning drive circuit 5, namely by controlling the timing for driving of the duty control transistor 17 (FIG. 3) or delete scanning transistor 22, (FIG. 5). Adjustment of a light transmission period of time of the organic EL element 13 can be performed also by controlling the timing for start of light emission given by the write scanning drive circuit 4, namely by controlling the timing for driving of the write scanning transistors 15, 19. The calculating section 8, scanning control drive section 7, write scanning drive circuit 4, and duty scanning drive circuit 5 form the “control unit” in the present invention.

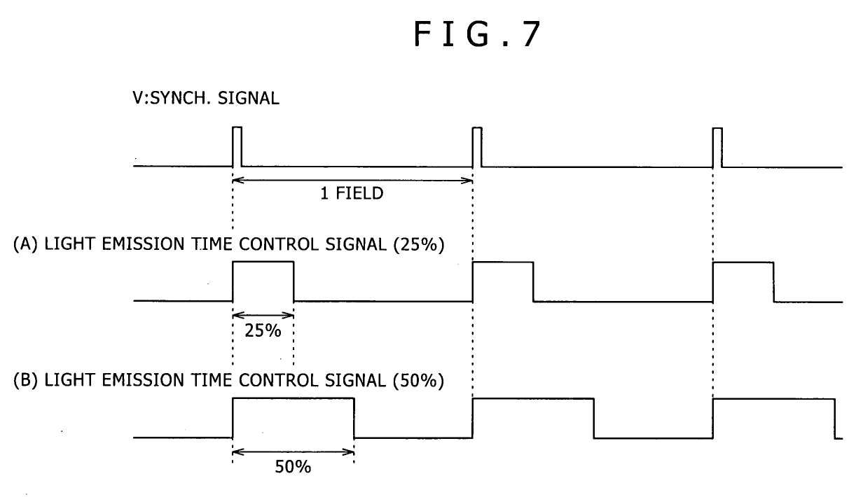

FIG. 7 shows an example of a control signal supplied from the scanning control drive section 7 to the duty scanning drive circuit 5. The organic EL element 13 used in the present invention is designed, for instance, so that, when the light emission period of time for one field period (16.67 ms) is 100% of the duty ratio, the average brightness for about 100 cd/m² is obtained for a light emission period of time equivalent to 25% of the duty ratio (4.167 ms), or the average brightness of about 200 cd/m² for a light emission period of time equivalent to 50% of the duty ratio (8.33 ms).

The light emission period of time, namely the light ON period of time (T12, T22) is controlled, as described above, according to the output timing for a signal SC2X supplied from the duty scanning drive circuit 5 to each pixel 12. Therefore, the control signal can be configured as the vertical start pulse VSP2 for adjusting an output of the signal SC2X so that the light emission period of time corresponding to the brightness set value calculated by the calculating section 8 can be obtained.

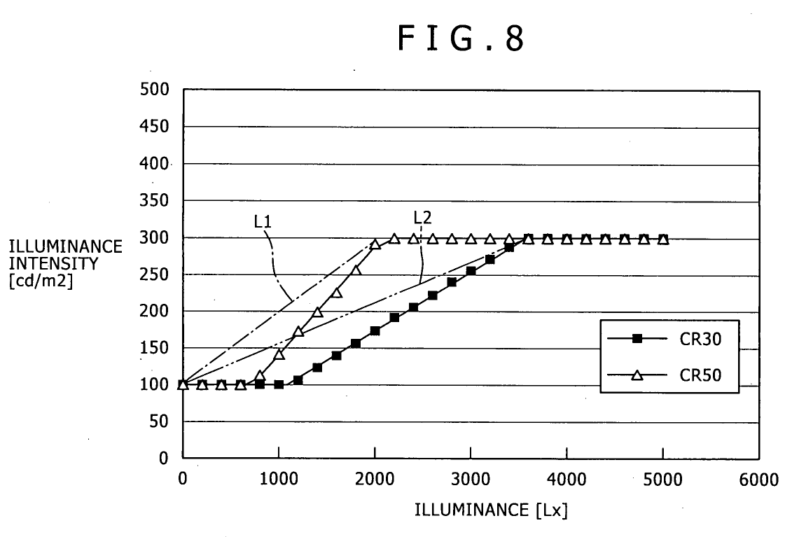

FIG. 8 shows an example of control over the illuminance of the organic EL element 13 corresponding to the illuminance of an ambient environment detected by the illuminance detector 9. In this embodiment, light emission period of time of the organic EL element 13 is controlled in response to brightness of external light, and in this step, the light emission period of time of the organic EL element 13 is controlled so that the display brightness satisfying the target screen contrast such as the contrast ratio of 30 or 50 can be obtained. Because of this feature, the visibility of the screen can be secured with unnecessary increase in power consumption suppressed.

Further, in the control over the light emission period of time of the organic EL element 13, a maximum value and a minimum value for the illumination intensity are set for defining a range for adjustment of the brightness for the purpose to prevent the screen brightness from being too bright or too dark. In the example shown in the figure, the minimum value for the illuminance intensity of the organic EL element 13 is set to 100 cd/m² (25% of the duty ratio), and the maximum value to 300 cd/m² (75% of the duty ratio), and the light emission period of time of the organic EL element 13 is controlled so that a predetermined screen contrast can be obtained in this range.

The target screen contrast is not always required to be constant. It is required only that the satisfying screen contrast can be obtained within the range for adjustment of the illumination intensity. For instance, in FIG. 8, the dash and dot line L1 indicates a case of control in the case where the target screen contrast is 50% of duty ratio, and the chain double-dashed line L2 indicates a case in which the target screen contrast is 30% of duty ratio.

As described above, with the present embodiment, brightness of a screen display can be adjusted in response to brightness of the ambient environment by controlling a light emission period of time of the organic EL element 13 within one scanning cycle for each pixel 12, so that the brightness of the screen display can easily and smoothly be performed.

Further a control signal independent from brightness information for the data line Y provided by the data control drive section 6 and data line drive circuit 3 is generated in the calculating section 8, and the control signal is supplied via the scanning control drive section 7 to the duty scanning drive circuit 5 to adjust brightness of each pixel, so that, even when brightness of a display is rather low, the dynamic range is not narrowed and degradation of image quality due to noises or non-uniformity of performances of elements never occurs, which ensures high quality screen display.

Further unnecessary increase of power consumption can be prevented, so that durability of the organic EL element 13 is improved, and therefore the high image quality can be preserved for a long period of time.

An embodiment of the present invention was described above, but the present invention is not limited to this embodiment, and various modifications are allowable and possible based on the technical idea of the present invention.

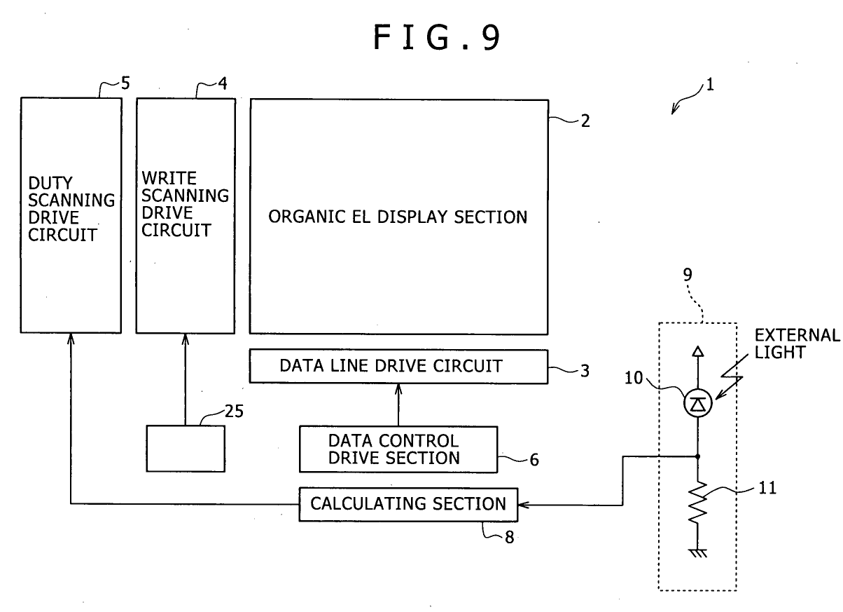

In the embodiment described above, a brightness set value calculated in the calculating section 8 is supplied via the scanning control drive section 7 to the duty scanning drive circuit 5, but for instance, as shown in FIG. 9, the brightness set value calculated in the calculating section 8 may directly be supplied to the duty scanning drive circuit 5. In this configuration, supply of a vertical clock or a vertical start pulse to the write scanning drive circuit 4 is executed by a write scanning control drive section 25 separately.

In the embodiment described above, the active matrix type of display apparatus was described by referring to a display device using an organic EL element, but the present invention is not limited to this configuration, and is applicable also to a display device using other types of self-luminous elements such as a light emitting diode (LED).

1. An active matrix type of display apparatus having scanning lines each for selecting a pixel with a predetermined scanning cycle, data lines each for giving brightness information for driving a pixel, and a pixel circuit for making a light emitting element emit light by controlling a current rate based on said brightness information, which are provided in the matrix state therein, said display apparatus comprising:
an illuminance detector for detecting illuminance of an ambient environment; and
a control unit for controlling a light emission period of time of said light emitting element in response to an output from said illuminance detector.

2. The active matrix type of display apparatus according to claim 1, wherein said control unit controls a light emission period of time of said light emitting element so that display brightness satisfying target screen contrast can be obtained.

3. The active matrix type of display apparatus according to claim 2, wherein a maximum value and a minimum value are set for said display brightness.

4. The active matrix type of display apparatus according to claim 1,
wherein said pixel circuit has an active element for write scanning controlled by said scanning line and capable of writing said brightness information given from said data line in a pixel; an active element for driving for controlling a rate of a current supplied to said light emitting element in response to the written brightness information; a storage capacity for storing therein said brightness information; and an active element for lighting out said light emitting element in the ON state, and
said control unit controls a light emission period of time of said light emitting element by controlling the timing for driving said active element for write scanning or said active element for lighting out.

5. The active matrix type of display apparatus according to claim 1, wherein said pixel circuit is a voltage write type of pixel circuit which writes said brightness information by controlling a voltage for said data line.

6. The active matrix type of display apparatus according to claim 1, wherein said pixel circuit is a current write type of pixel circuit which writes said brightness information by controlling a current for said data line.

7. The active matrix type of display apparatus according to claim 1, wherein said light emitting element is an organic electroluminescence element.

8. A method of driving an active matrix type of display apparatus having scanning lines each for selecting a pixel with a predetermined scanning cycle, data lines each for giving brightness information for driving a pixel, and a pixel circuit for making a light emitting element emit light by controlling a current rate based on said brightness information, which are provided in the matrix state therein, said display apparatus making said light emitting element emit light, based on selection scanning for said scanning line by a scanning drive unit and selection driving by a data drive unit via said data line, said method comprising the steps of:
detecting illuminance of an ambient environment;
calculating a light emission period of time of said light emitting element in response to said detected illuminance; and
controlling said scanning drive unit in response to said calculated light emission period of time.

9. The method of driving an active matrix type of display apparatus according to claim 8, wherein at least a light emission period of time of said light emitting element is calculated to obtain display brightness satisfying the target screen contrast in the step of calculating a light emission period of time of said light emitting element.

10. The active matrix type of display apparatus according to claim 9, wherein a maximum value and a minimum value are set for said display brightness.
